(19) United States
(12) Patent Application Publication
(10) Pub. No.: US 2026/0316287 A1
(43) Pub. Date: Oct. 15, 2026

(54) MOTION LEARNING SYSTEM

(71) Applicant: TOYOTA JIDOSHA KABUSHIKI KAISHA, Toyota-shi (JP)

(72) Inventors: Tomohiro MATSUDA, Toyota-shi (JP); Masateru SAITO, Anjo-shi (JP); Shun SATO, Aichi-gun (JP)

(73) Assignee: TOYOTA JIDOSHA KABUSHIKI KAISHA, Toyota-shi (JP)

(21) Appl. No.: 19/462,046

(22) Filed: Jan. 28, 2026

(30) Foreign Application Priority Data
Mar. 28, 2025 (JP) 2025-056224

(51) Int. Cl. B25J 9/16; G05B 13/02; G06V 10/74; G06V 40/20

(52) U.S. Cl. CPC B25J 9/1697; B25J 9/163; G05B 13/028; G06V 10/761; G06V 40/20

(57) ABSTRACT

A motion learning system includes a humanoid robot, a camera provided in the humanoid robot, the camera being configured to capture a robot-view video that is a first-person-view video of the humanoid robot, and a learning unit configured to learn a motion of the humanoid robot such that a difference between a motion of a model worker who is a human worker and the motion of the humanoid robot is reduced, based on a worker-view video that is a first-person-view video of the model worker, the worker-view video being captured during a period in which the model worker performs a predetermined motion, and the robot-view video.

### CROSS-REFERENCE TO RELATED APPLICATION

This application claims priority to Japanese Patent Application No. 2025-056224 filed on Mar. 28, 2025. The disclosure of the above-identified application, including the specification, drawings, and claims, is incorporated by reference herein in its entirety.

### BACKGROUND

### 1. Technical Field

The present disclosure relates to a motion learning system.

### 2. Description of Related Art

As a method of causing a humanoid robot to reproduce a human motion, a method of using a Hidden Markov Model is known (for example, Japanese Unexamined Patent Application Publication No. 2004-330361 (JP 2004-330361 A)).

### SUMMARY

However, in a case of using the Hidden Markov Model, since a state transition sequence needs to be calculated, generation of motion data for causing the humanoid robot to imitate the motion of the human worker requires time. Therefore, a technology is required that facilitates learning for causing the humanoid robot to imitate the motion of the human worker.

The present disclosure can be implemented as the following aspects.

(1) According to an aspect of the present disclosure, a motion learning system is provided. The motion learning system includes:a humanoid robot;a camera provided in the humanoid robot, the camera being configured to capture a robot-view video that is a first-person-view video of the humanoid robot;and a learning unit configured to learn a motion of the humanoid robot such that a difference between a motion of a model worker who is a human worker and the motion of the humanoid robot is reduced, based on a worker-view video that is a first-person-view video of the model worker, the worker-view video being captured during a period in which the model worker performs a predetermined motion, and the robot-view video.

According to the motion learning system of the aspect, learning for causing the humanoid robot to imitate the motion of the human worker can be facilitated.

(2) In the motion learning system of the aspect, the motion learning system further includes:

a visibility score calculation unit configured to calculate a visibility score that is a similarity between the worker-view video and the robot-view video; and

an action score calculation unit, in which:

the action score calculation unit may be configured to

estimate a robot action that is a work content of the humanoid robot by using the robot-view video, and

calculate an action score that is a similarity between the robot action and a worker action that is a work content of the model worker estimated by using the worker-view video; and

the learning unit is configured to learn the motion of the humanoid robot such that the visibility score and the action score are increased.

According to the motion learning system of the aspect, learning for causing the humanoid robot to accurately imitate the motion of the human worker can be facilitated.

(3) In the motion learning system of the aspect, the visibility score calculation unit may be configured to calculate the visibility score by comparing an object appearing in the worker-view video with an object appearing in the robot-view video.

According to the motion learning system of the aspect, the visibility score calculation unit can calculate the visibility score more accurately.

(4) In the motion learning system of the aspect, the learning unit may be configured to perform reinforcement learning of a robot motion model, the robot motion model being a trained model configured to output motion control information for controlling the motion of the humanoid robot when the robot-view video is input.

(5) In the motion learning system of the aspect, the motion learning system may further include a motion controller configured to control the motion of the humanoid robot based on a learning result of the learning unit.

According to the motion learning system of the aspect, the humanoid robot can be easily caused to reproduce the motion of the human worker.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram showing a schematic configuration of a motion learning system;

FIG. 2 is an explanatory diagram showing a schematic configuration of a control device; and

FIG. 3 is a flowchart showing a learning method for causing the humanoid robot to imitate the motion of the model worker.

### DETAILED DESCRIPTION OF EMBODIMENTS

### A. First Embodiment

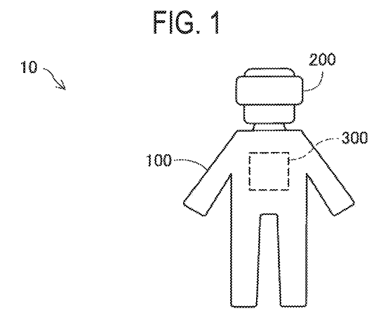

FIG. 1 is an explanatory diagram showing a schematic configuration of a motion learning system 10. The motion learning system 10 includes a humanoid robot 100, a camera 200 provided in the humanoid robot 100, and a control device 300. The motion learning system 10 is a system that performs learning for causing the humanoid robot 100 to imitate the motion of the human worker. The humanoid robot 100 is also referred to as a humanoid robot.

The camera 200 captures a first-person-view video of the humanoid robot 100. In the present embodiment, the camera 200 is a wearable camera mounted on a head of the humanoid robot 100. In the present embodiment, the camera 200 is a so-called first-person-view (FPV) camera, and is attachably and detachably provided on the humanoid robot 100. The camera 200 may be provided integrally with the humanoid robot 100 on the head of the humanoid robot 100. The camera 200 captures images of the surroundings of the humanoid robot 100 from the viewpoint of the humanoid robot 100. Hereinafter, the video captured by the camera 200 is referred to as a robot-view video.

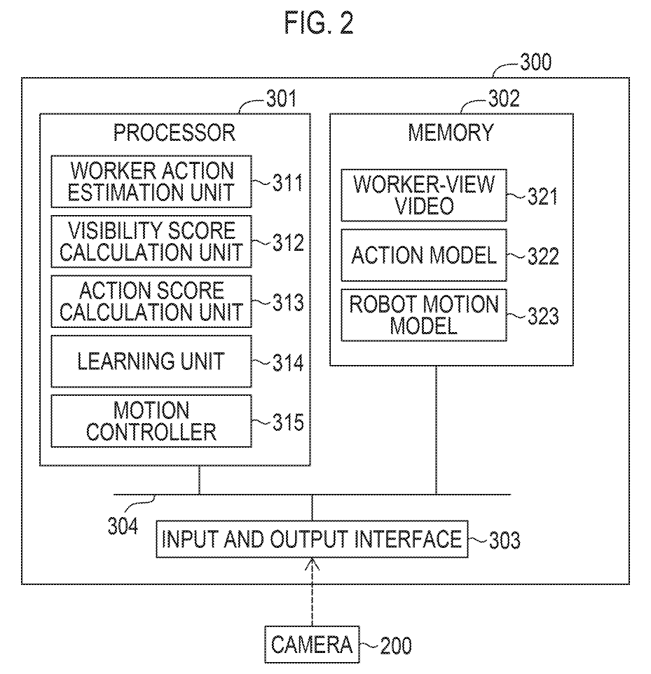

FIG. 2 is an explanatory diagram showing a schematic configuration of the control device 300. The control device 300 is a computer including a processor 301, a memory 302, an input and output interface 303, and an internal bus 304. The processor 301, the memory 302, and the input and output interface 303 are connected to be bidirectionally communicable with each other via the internal bus 304. The camera 200 is connected to the input and output interface 303. The camera 200 may be connected to the input and output interface 303 by wired communication or may be connected to the input and output interface 303 by wireless communication. In the present embodiment, the control device 300 is mounted on the humanoid robot 100.

The memory 302 includes a random access memory (RAM) in addition to a non-volatile memory such as an electrically erasable programmable read-only memory (EEPROM). The memory 302 stores a worker-view video 321, an action model 322, a robot motion model 323, and a control program (not shown).

The worker-view video 321 is a first-person-view video of the model worker that is captured during a period in which the model worker who is a human worker performs a predetermined motion. The worker-view video 321 is a video captured by a wearable camera mounted on the head of the model worker. The wearable camera mounted on the model worker is a so-called FPV camera, and images the surroundings of the model worker from the viewpoint of the model worker. Here, it is preferable that the position of the wearable camera mounted on the model worker is the same as the position of the camera 200 provided in the humanoid robot 100. For example, when the wearable camera is mounted on a left temporal part of the model worker, it is preferable that the camera 200 is provided on a left temporal part of the humanoid robot 100. The predetermined motion performed by the model worker is a motion related to the manufacture of an article. Motions relating to manufacture of an article include, for example, object-targeted motions such as connector insertion, bolt tightening, manual holding of an object, and carrying of a member, and also motions incidental to article manufacture such as a walking motion when a model worker himself or herself moves. The memory 302 stores one worker-view video 321. The predetermined motion performed by the model worker may be a motion other than the manufacture of the article.

The action model 322 is a learning model that receives the worker-view video 321 or the robot-view video as an input, and outputs a work content performed by the model worker or the humanoid robot 100 during a period in which the input video is captured. The action model 322 is a trained learning model in which machine learning is performed in advance using a training data set. As the action model 322, for example, a convolutional neural network that is trained by supervised learning using a training data set can be used. The training data set includes, for example, a worker-view video and a label indicating a work content performed by the model worker during a period in which the worker-view video is captured.

The robot motion model 323 is a learning model that outputs motion control information for controlling the motion of the humanoid robot 100 when the robot-view video is input. The motion control information is, for example, a command value such as an angle of a joint of an arm part or a leg part of the humanoid robot 100, a direction in which the arm part or the leg part is moved, and a speed at which the arm part or the leg part is moved.

The processor 301 executes the control program stored in the memory 302. As a result, the processor 301 functions as a worker action estimation unit 311, a visibility score calculation unit 312, an action score calculation unit 313, a learning unit 314, and a motion controller 315.

The worker action estimation unit 311 estimates the worker action that is the work content of the model worker by using the worker-view video 321. The worker action is, for example, connector insertion, bolt tightening, or manual holding of an object. The worker action estimation unit 311 estimates the worker action by using the action model 322. Specifically, the worker action estimation unit 311 inputs the worker-view video 321 to the action model 322 and estimates the worker action that is the work content output from the action model 322 as the worker action performed by the model worker during the period in which the worker-view video 321 is captured.

The visibility score calculation unit 312 calculates the visibility score that is a similarity between the worker-view video 321 and the robot-view video by comparing the worker-view video 321 with the robot-view video. Specifically, the visibility score calculation unit 312 calculates the visibility score by comparing an object appearing in the worker-view video 321 with an object appearing in the robot-view video. The visibility score calculation unit 312 compares, for example, a position of a hand of the model worker, a connector gripped by the model worker, a workbench, or the like appearing in the worker-view video 321 with a position of a hand of the humanoid robot 100, a connector gripped by the humanoid robot 100, a workbench, or the like appearing in the robot-view video. As a result, the visibility score calculation unit 312 calculates the visibility score. The higher the visibility score, the more similar the worker-view video 321 is to the robot-view video.

The action score calculation unit 313 estimates the robot action that is the work content of the humanoid robot 100 by using the robot-view video. The robot action is, for example, connector insertion, bolt tightening, or manual holding of an object. The action score calculation unit 313 inputs the robot-view video to the action model 322 and estimates the robot action that is the work content output from the action model 322 as the robot action performed by the humanoid robot 100 during the period in which the robot-view video is captured. In addition, the action score calculation unit 313 calculates the action score that is a similarity between the worker action and the robot action. The action score calculation unit 313 calculates the action score by determining whether the worker action estimated by the worker action estimation unit 311 and the robot action estimated by the action score calculation unit 313 match. The higher the action score, the more similar the worker action is to the robot action. For example, the action score calculation unit 313 sets the action score to 1 when the worker action and the robot action match, and sets the action score to 0 when the worker action and the robot action do not match.

The learning unit 314 learns the motion of the humanoid robot 100 such that a difference between the motion of the model worker and the motion of the humanoid robot 100 is reduced, based on the worker-view video 321 and the robot-view video. In the present embodiment, the learning unit 314 learns the motion of the humanoid robot 100 such that the visibility score and the action score are increased. The learning unit 314 learns the motion of the humanoid robot 100 by performing reinforcement learning of the robot motion model 323. The learning unit 314 performs machine learning of the robot motion model 323 by reinforcement learning such as Q-learning or a Monte Carlo method. The learning unit 314 may perform machine learning of the robot motion model 323 by reinforcement learning such as a deep Q-network (DQN) using deep learning.

The motion controller 315 controls the motion of the humanoid robot 100 based on the learning result of the learning unit 314. Specifically, the motion controller 315 controls the motion of the humanoid robot 100 based on the robot motion model 323 that is trained by the learning unit 314. The motion controller 315 controls the motion of each unit of the humanoid robot 100 in accordance with the motion control information output from the robot motion model 323.

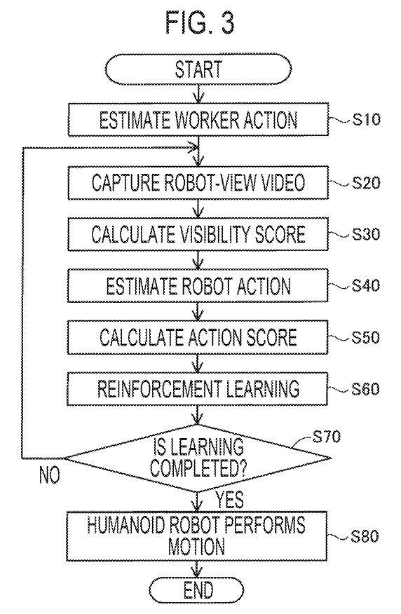

FIG. 3 is a flowchart showing a learning method for causing the humanoid robot 100 to imitate the motion of the model worker. In S10, the worker action estimation unit 311 estimates the worker action that is the work content performed by the model worker during the period in which the worker-view video 321 is captured by using the worker-view video 321. The worker action estimation unit 311 inputs the worker-view video 321 to the action model 322 and estimates the worker action that is the work content output from the action model 322 as the worker action performed by the model worker during the period in which the worker-view video 321 is captured.

In S20, the motion controller 315 controls the motion of the humanoid robot 100 based on the robot motion model 323. The camera 200 captures the robot-view video while the humanoid robot 100 is performing a motion. The captured robot-view video is transmitted to the control device 300 in real time. The motion controller 315 inputs the robot-view video captured by the camera 200 to the robot motion model 323 and controls the motion of the humanoid robot 100 in accordance with the motion control information output from the robot motion model 323. The robot-view video transmitted from the camera 200 is stored in the memory 302.

In S30, the visibility score calculation unit 312 calculates the visibility score by comparing the worker-view video 321 with the robot-view video captured in S20. The visibility score calculation unit 312 compares the worker-view video 321 and the robot-view video at a plurality of time points at which an elapsed time from the start of the predetermined motion by the model worker equals an elapsed time from the start of the motion of the humanoid robot 100. The visibility score calculation unit 312 compares the worker-view video 321 and the robot-view video at predetermined time intervals. The visibility score calculation unit 312 compares the worker-view video 321 and the robot-view video, for example, every 0.1 seconds. The calculated visibility score is stored in the memory 302. The visibility score calculation unit 312 may calculate the visibility score by comparing the worker-view video 321 with the robot-view video captured by the camera 200 in real time.

In S40, the action score calculation unit 313 estimates the robot action performed by the humanoid robot 100 in S20. The action score calculation unit 313 inputs the robot-view video captured in S20 to the action model 322 and estimates the robot action performed by the humanoid robot 100 in S20 as the work content output from the action model 322.

In S50, the action score calculation unit 313 calculates the action score indicating the similarity between the worker action estimated in S10 and the robot action estimated in S40. The calculated action score is stored in the memory 302.

In S60, the learning unit 314 performs reinforcement learning of the robot motion model 323 such that the difference between the motion of the model worker and the motion of the humanoid robot 100 is reduced. The learning unit 314 performs reinforcement learning of the robot motion model 323 such that the humanoid robot 100 performs a motion that obtains a higher reward, using the visibility score and the action score as rewards in the reinforcement learning.

In S70, the control device 300 determines whether the learning of the robot motion model 323 is completed. The control device 300 determines that the learning of the robot motion model 323 is completed when, for example, the visibility score calculated in S30 is higher than a predetermined reference value and the action score calculated in S50 is 1. When determination is made that the learning of the robot motion model 323 is completed, S80 is executed. When determination is made that the learning of the robot motion model 323 is not completed, the processing returns to S20.

In S80, the motion controller 315 controls the motion of the humanoid robot 100 based on the learning result of the learning unit 314. The motion controller 315 controls the motion of the humanoid robot 100 based on the robot motion model 323 of which the learning is completed, and causes the humanoid robot 100 to execute the motion related to the manufacture of the article. Specifically, the motion controller 315 inputs the robot-view video captured by the camera 200 to the robot motion model 323 of which the learning is completed in real time. The motion controller 315 controls the motion of the humanoid robot 100 in accordance with the motion control information output from the robot motion model 323.

The motion learning system 10 according to the first embodiment described above includes the humanoid robot 100, the camera 200 that captures the robot-view video, and the learning unit 314. The learning unit 314 learns the motion of the humanoid robot 100 such that a difference between the motion of the model worker and the motion of the humanoid robot 100 is reduced, based on the worker-view video 321 and the robot-view video. Therefore, learning for causing the humanoid robot 100 to imitate the motion of the human worker can be easily performed.

In addition, in the present embodiment, the visibility score calculation unit 312 calculates the visibility score that is the similarity between the worker-view video 321 and the robot-view video. The action score calculation unit 313 estimates the robot action by using the robot-view video, and calculates the action score that is the similarity between the worker action and the robot action. The learning unit 314 learns the motion of the humanoid robot 100 such that the visibility score and the action score are increased. Therefore, learning for causing the humanoid robot 100 to accurately imitate the motion of the human worker can be easily performed.

In addition, in the present embodiment, the visibility score calculation unit 312 calculates the visibility score by comparing the object appearing in the worker-view video 321 with the object appearing in the robot-view video. Therefore, the visibility score calculation unit 312 can calculate the visibility score more accurately.

In addition, in the present embodiment, the motion controller 315 controls the motion of the humanoid robot 100 based on the learning result of the learning unit 314. Therefore, it is possible to easily cause the humanoid robot 100 to reproduce the motion of the human worker.

### B. Other Embodiments

(B-1) In the embodiment, the worker-view video 321 is stored in the memory 302 in advance. Alternatively, the worker-view video 321 may not be stored in the memory 302 in advance. In this case, the control device 300 acquires the worker-view video 321 from an external storage device or the like. In addition, the control device 300 may directly acquire the worker-view video 321 from the wearable camera mounted on the model worker.

(B-2) In the embodiment, the motion learning system 10 includes the worker action estimation unit 311. Alternatively, the motion learning system 10 need not include the worker action estimation unit 311. In this case, the worker action is stored in the memory 302 in advance.

(B-3) In the embodiment, the visibility score calculation unit 312 calculates the visibility score by comparing the object appearing in the worker-view video 321 with the object appearing in the robot-view video. Alternatively, the visibility score calculation unit 312 may calculate the visibility score by comparing a direction in which the model worker faces with a direction in which the humanoid robot 100 faces. The direction in which the model worker faces is estimated by using the worker-view video 321, and the direction in which the humanoid robot 100 faces is estimated by using the robot-view video.

(B-4) In the embodiment, the motion learning system 10 includes the visibility score calculation unit 312. Alternatively, the motion learning system 10 may not include the visibility score calculation unit 312. In this case, the learning unit 314 learns the motion of the humanoid robot 100 such that the action score is increased. Specifically, the learning unit 314 performs reinforcement learning of the robot motion model 323 such that the humanoid robot 100 performs a motion that obtains a higher reward, using the action score as a reward in the reinforcement learning.

(B-5) In the embodiment, the motion learning system 10 includes the action score calculation unit 313. Alternatively, the motion learning system 10 may not include the action score calculation unit 313. In this case, the learning unit 314 learns the motion of the humanoid robot 100 such that the visibility score is increased. Specifically, the learning unit 314 performs reinforcement learning of the robot motion model 323 such that the humanoid robot 100 performs a motion that obtains a higher reward, using the visibility score as a reward in the reinforcement learning.

(B-6) In the embodiment, the motion controller 315 controls the motion of the humanoid robot 100 based on the learning result of the learning unit 314. Alternatively, the motion controller 315 need not control the motion of the humanoid robot 100 based on the learning result of the learning unit 314. That is, S80 of the learning method shown in FIG. 3 need not be executed.

(B-7) In the embodiment, the control device 300 is mounted on the humanoid robot 100. Alternatively, the control device 300 may be installed outside the humanoid robot 100 and may be connected to the humanoid robot 100 by wired communication or wireless communication.

The present disclosure is not limited to the embodiments described above, and can be implemented with various configurations without departing from the gist of the present disclosure. For example, the technical features in the embodiment corresponding to the technical features in each aspect described in the section of the summary can be appropriately replaced or combined in order to solve some or all of the problems described above. Alternatively, some or all of the effects described above can be achieved by appropriately performing the replacement or the combination. In a case where the technical features are not described as being always needed in the present specification, the features can be deleted as appropriate.

What is claimed is:

1. A motion learning system comprising:
a humanoid robot;
a camera provided in the humanoid robot, the camera being configured to capture a robot-view video that is a first-person-view video of the humanoid robot; and
a learning unit configured to learn a motion of the humanoid robot such that a difference between a motion of a model worker who is a human worker and the motion of the humanoid robot is reduced, based on a worker-view video that is a first-person-view video of the model worker, the worker-view video being captured during a period in which the model worker performs a predetermined motion, and the robot-view video.

2. The motion learning system according to claim 1, further comprising:
a visibility score calculation unit configured to calculate a visibility score that is a similarity between the worker-view video and the robot-view video; and
an action score calculation unit, wherein:
the action score calculation unit is configured to
estimate a robot action that is a work content of the humanoid robot by using the robot-view video, and
calculate an action score that is a similarity between the robot action and a worker action that is a work content of the model worker estimated by using the worker-view video; and
the learning unit is configured to learn the motion of the humanoid robot such that the visibility score and the action score are increased.

3. The motion learning system according to claim 2, wherein the visibility score calculation unit is configured to calculate the visibility score by comparing an object appearing in the worker-view video with an object appearing in the robot-view video.

4. The motion learning system according to claim 1, wherein the learning unit is configured to perform reinforcement learning of a robot motion model, the robot motion model being a learning model configured to output motion control information for controlling the motion of the humanoid robot when the robot-view video is input.

5. The motion learning system according to claim 1, further comprising a motion controller configured to control the motion of the humanoid robot based on a learning result of the learning unit.
